(19) United States
(12) Patent Application Publication
(10) Pub. No.: US 2013/0041578 A1
(43) Pub. Date: Feb. 14, 2013

(54) VEHICLE-MOUNTED DEVICE, VEHICLE-MOUNTED COMMUNICATION DEVICE, AND VEHICLE-MOUNTED INFORMATION PROCESSOR

(71) Applicant: Hiroyuki Aono, Susono-shi (JP)

(72) Inventor: Hiroyuki Aono, Susono-shi (JP)

(73) Assignee: TOYOTA JIDOSHA KABUSHIKI KAISHA, Aichi-ken (JP)

(21) Appl. No.: 13/642,930

(22) PCT Filed: Apr. 27, 2010
(86) PCT No.: PCT/JP10/57479

§ 371 Date: Oct. 23, 2012

(51) Int. Cl. G06F 17/00

(52) U.S. Cl. 701/300

(57) ABSTRACT

Provided is a vehicle-mounted device, which can reduce the amount of data of the positional information of other vehicles captured by a communication device, and also provided are a vehicle-mounted communication device and a vehicle-mounted information processor, which are used in the vehicle-mounted device. The vehicle-mounted device discerns a positional relationship, which is formed on the basis of map information, with an object captured by a communication device. The positional relationship is discerned by means of an information processor, which processes positional information of the object as required. The communication device is provided with a coordinate conversion unit, which converts the positional information of the captured object into coordinate information of a coordinate system that is set at a limited resolution with respect to the map information, and the communication device transfers to the information processor the coordinate information produced by the conversion.

### TECHNICAL FIELD

The present invention relates to a vehicle-mounted device that discerns positional information of other vehicles received in a vehicle, a vehicle-mounted communication device, and a vehicle-mounted information processor constituting the vehicle-mounted device.

### BACKGROUND ART

Vehicle are often provided with a vehicle-mounted device that obtains positional information relating to the current positions of other vehicles by using radio communication and provides the positions of other vehicles determined on the basis of the positional information to a driver. Recently, in those vehicle-mounted devices, the positional information transmitted/received between the vehicles by using radio communication has been often expressed by using longitudes and latitudes in general. By using the positional information expressed by the longitudes and latitudes as above, even if the positional information is transmitted/received with unspecified other vehicles, the vehicle that has obtained the positional information can correctly discern/process the obtained positional information.

As the vehicle-mounted device using the positional information expressed by the longitude and latitude as above, a device described in Patent Document 1, for example, is conventionally known. In the vehicle-mounted device described in this Patent Document 1, when positional information is received from another vehicle, vehicle positional information of the other vehicle expressed by the longitude and latitude on a map is generated from the positional information. As a result, the vehicle positional information of the other vehicle formed of the longitude and latitude can be discerned/processed by the vehicle-mounted device and various devices connected to the device. That is, the vehicle-mounted device is capable of providing the driver with the position of the other vehicle determined on the basis of the positional information on the map formed of the longitude and latitude.

### PRIOR ART DOCUMENT

### Patent Document

### Patent Document 1

Japanese Laid-Open Patent Publication No. 2005-328283

### SUMMARY OF THE INVENTION

### Problems that the Invention is to Solve

In the device described in Patent Document 1, even though the positional information expressed by longitude and latitude is used, if the longitude and latitude are to be expressed up to one hundredth arcsecond (angle), each of them requires 28 bits. That is, the positional information expressed by longitude and latitude needs a relatively large data amount and it is transmitted/received as data requiring 56 bits, for example.

Particularly, in recent years, information transmission between a plurality of vehicle-mounted devices has been performed through a vehicle-mounted network shared by the plurality of devices in a vehicle, and thus, reduction of a communication load of the vehicle-mounted network has become a new task. That is, in view of the reduction of the communication load of the vehicle-mounted network, the data amount of such positional information has become significant. In the case of vehicle-to-vehicle communication capable of handling positional information of 400 vehicles per 0.1 seconds (time), the data amount of the position information per second becomes 224 kilobits. On the other hand, a local CAN, one of the vehicle-mounted networks, has a maximum communication capacity of 500 kilobits per second (time). Thus, if the positional information handled by the vehicle-to-vehicle communication is to be transmitted as it is to another device in the network through the local CAN, about a half of a communication band of the local CAN is occupied by the positional information, and the communication band for other communication might be compressed. Moreover, a large quantity of communication data might cause communication delay due to an increase of possibility of collision with other communication data and may lower communication efficiency of the local CAN.

Accordingly, it is an objective of the present invention to provide a vehicle-mounted device capable of reducing a data amount of positional information of other vehicles obtained by a communication device, a vehicle-mounted communication device, and a vehicle-mounted information processor constituting the vehicle-mounted device.

### Means for Solving the Problems

Means for solving the above problems and its working effect will be described below.

To achieve the foregoing objective, the present invention provides a vehicle-mounted device, which processes, using a vehicle-mounted information processor, positional information of a target obtained by a vehicle-mounted communication device as required and discerns a positional relationship with the target on the basis of map information. The vehicle-mounted communication device is provided with a coordinate conversion unit, which converts the obtained positional information of the target to coordinate information of a coordinate system set to limited resolution with respect to the map information. The vehicle-mounted device transfers the converted coordinate information to the vehicle-mounted information processor.

According to this configuration, positional information of a target outside the vehicle obtained by the vehicle-mounted communication device, which information corresponds to map information specifying the position on the basis of a wide coordinate system such as a geographical coordinate system, is converted to coordinate information of a coordinate system set to limited resolution, whereby the data amount can be reduced. As a result, a data amount transferred from the vehicle-mounted communication device to the vehicle-mounted information processor becomes small, and a communication load of the data transfer is also reduced.

The vehicle-mounted information processor may be provided with a display device, which visualizes and displays the positional information transferred from the vehicle-mounted communication device together with the map information on a screen. The coordinate conversion unit may set the coordinate system corresponding to the screen resolution of the display device to a coordinate system set to the limited resolution and converts the obtained positional information of the target to the coordinate information of the coordinate system according to the screen resolution of the display device.

According to this configuration, since the coordinate system set to limited resolution is a coordinate system corresponding to the screen resolution of a display device, the vehicle-mounted communication device can convert the positional information of the target to the coordinate information that is of the coordinate system suitable for display on the display device. As a result, the data amount transferred from the vehicle-mounted communication device to the vehicle-mounted information processor is decreased, and moreover, the target can be easily displayed with the map on the display device.

The vehicle-mounted information processor may be provided with a conversion factor computing unit, which calculates a conversion factor of coordinate conversion by the coordinate conversion unit from a scale in each case of the map information and the screen resolution of the display device and transfers the calculated conversion factor to the coordinate conversion unit. The coordinate conversion unit may convert the obtained positional information of the target to the coordinate information of the coordinate system corresponding to the screen resolution of the display device on the basis of the conversion factor transferred from the conversion factor computing unit.

According to this configuration, the positional information of the target obtained by the vehicle-mounted communication device is converted to coordinate information corresponding to the screen resolution of the display device by a conversion factor calculated in accordance with the screen resolution of the display device and a scale of map information. As a result, the vehicle-mounted communication device can appropriately match the coordinate information of the target on the display device with the screen resolution of the display device and the scale of the map information changing in various ways timely.

The conversion factor transferred from the conversion factor computing unit to the coordinate conversion unit may include information indicating a screen center position of the display device corresponding to the map information. The coordinate conversion unit may convert the obtained positional information of the target as the coordinate information from the screen center position.

According to this configuration, since the coordinate conversion unit converts the positional information of the target to coordinate information from the screen center position, the positional information of the target becomes a numerical value of the difference with respect to the screen center position as the center, and the data amount is reduced. As a result, the coordinate system of the positional information of the target can be converted to the coordinate information based on the screen center position, the value of the coordinate information becomes a relatively small value according to the screen resolution, and the data amount of the coordinate information can be reduced.

The vehicle-mounted communication device may obtain the positional information of each communication destination vehicle as the positional information of the target together with identification information of each of those vehicles via vehicle-to-vehicle communication. The coordinate conversion unit may convert the positional information of each communication destination vehicle identified by the identification information to the coordinate information of the coordinate system and transfer the converted coordinate information of each communication destination vehicle to the vehicle-mounted information processor.

According to this configuration, the position information of other vehicles obtained through the vehicle-mounted communication device is converted to the coordinate information, whereby the data amount is reduced. As a result, by transferring the coordinate information, data communication between the vehicle-mounted communication device and the vehicle-mounted information processor is decreased as compared with the transfer of positional information, and a communication load of communication for transfer can be reduced.

Moreover, since the reduction of the communication load can also increase a quantity of coordinate information of other vehicles that can be transferred, the number of vehicles that can be recognized by the vehicle-mounted information processor can be increased so as to further sophisticate driving support.

The vehicle-mounted communication device may be further provided with a function of calculating a moving amount of each communication destination vehicle identified by the identification information. Regarding coordinate information converted by the coordinate conversion unit, the vehicle-mounted communication device may transfer information corresponding to a moving amount of each vehicle calculated to the vehicle-mounted information processor.

According to this configuration, since the coordinate information based on a movement amount of the target is transferred from the vehicle-mounted communication device to the vehicle-mounted information processor, the data amount can be made smaller than that in the case of transfer of positional information. In the case of the movement amount, since the movement amount of the target is decreased by making a cycle for calculation of the movement amount short, the data amount can be further decreased.

The vehicle-mounted communication device and the vehicle-mounted information processor may be connected to each other through a vehicle-mounted network, and the converted coordinate information may be transmitted/received through the vehicle-mounted network.

According to this configuration, since the coordinate information, whose data amount is made smaller than that of the positional information of the target, is transmitted through the vehicle-mounted network, the communication load of the vehicle-mounted network is reduced. The reduction of the communication load of the vehicle-mounted network makes an influence on other communication using the vehicle-mounted network smaller, and, for a communication system of the vehicle, communication efficiency is favorably maintained.

The positional information of the target, which is obtained by the vehicle-mounted communication device and converted by the coordinate conversion unit to the coordinate information, may include at least one of a value of latitude and a value of longitude.

According to this configuration, a data amount of 26 bits, for example, required for a value indicating longitude or latitude (if it is displayed up to one hundredth arcseconds (angle)) is converted to coordinate information having a smaller data amount than that. As a result, the data amount transmitted to the vehicle-mounted information processor can be made smaller than the case where the value of the latitude or the value of the longitude is transmitted as it is, and a communication load of data communication between the vehicle-mounted communication device and the vehicle-mounted information processor can be reduced.

To achieve the foregoing objective, the present invention provides a vehicle-mounted communication device, which obtains positional information of a target whose positional relationship is discerned on the basis of map information by means of processing in a vehicle-mounted information processor as required. The vehicle-mounted communication device includes a coordinate conversion unit, which converts the obtained positional information of the target to coordinate information of a coordinate system set to limited resolution with respect to the map information. The vehicle-mounted communication device transfers the converted coordinate information to the vehicle-mounted information processor.

According to this configuration, positional information of the target outside the vehicle obtained by the vehicle-mounted communication device, which information corresponds to map information specifying the position based on the wide coordinate system such as a geographical coordinate system, is converted to the coordinate information of the coordinate system set to limited resolution, whereby the data amount can be reduced. As a result, the data amount transferred from the vehicle-mounted communication device to the vehicle-mounted information processor becomes small, and the communication load of the data transfer is reduced.

The vehicle-mounted information processor may be provided with a display device, which visualizes and displays the positional information together with the map information on a screen. The coordinate conversion unit may set the coordinate system corresponding to the screen resolution of the display device to a coordinate system set to the limited resolution and converts the obtained positional information of the target to the coordinate information of the coordinate system according to the screen resolution of the display device.

According to this configuration, since the coordinate system set to limited resolution is a coordinate system corresponding to the screen resolution of the display device, the vehicle-mounted communication device can convert the positional information of the target to the coordinate information that is of the coordinate system suitable for display on the display device. As a result, the data amount transferred from the vehicle-mounted communication device to the vehicle-mounted information processor is decreased and moreover, the target can be easily displayed with the map on the display device.

To achieve the foregoing objective, the present invention provides a vehicle-mounted information processor, which processes positional information of a target obtained by a vehicle-mounted communication device as required and discerns the positional relationship with the target on the basis of map information. The vehicle-mounted information processor includes a conversion factor calculation unit, which calculates a conversion factor for converting the positional information of the target obtained by the vehicle-mounted communication device to coordinate information of a coordinate system set to limited resolution with respect to the map information. The vehicle-mounted information processor transfers the calculated conversion factor to the vehicle-mounted communication device.

According to this configuration, the positional information of the target outside the vehicle obtained by the vehicle-mounted communication device, which information corresponds to map information specifying the position on the basis of the wide coordinate system such as a geographical coordinate system, is converted to the coordinate information of the coordinate system set to the limited resolution used by the vehicle-mounted information processor for recognition of the position of the target, whereby the data amount can be reduced. As a result, the data amount transferred from the vehicle-mounted communication device to the vehicle-mounted information processor becomes small, and the communication load of data transfer is reduced.

The vehicle-mounted information processor may further include a display device, which visualizes and displays the positional information transferred from the vehicle-mounted communication device together with the map information on a screen. The conversion factor calculation unit may calculate the conversion factor from a scale in each case of the map information and the screen resolution of the display device.

According to this configuration, since the conversion factor to the coordinate system set to limited resolution is calculated as a conversion factor to the coordinate system according to the scale of the map information in each case and the screen resolution of the display device, the vehicle-mounted communication device can convert the positional information which is of the target to the coordinate information of the coordinate system suitable for display on the display device. As a result, the data amount transferred from the vehicle-mounted communication device to the vehicle-mounted information processor becomes small and moreover, display of the target with the map on the display device is facilitated.

### BRIEF DESCRIPTION OF THE DRAWINGS

FIG. 1 is a block diagram schematically illustrating an outline of a vehicle-mounted device according a first embodiment of the present invention;

FIG. 2 is a schematic diagram illustrating an image displayed on a screen on the basis of positional information processed by the device of the first embodiment;

FIG. 3 is a plan view illustrating an example of a travel environment in which the device of the first embodiment processes the positional information;

FIG. 4 is a diagram schematically illustrating information handled in the first embodiment, in which (a) is a conceptual diagram illustrating a data structure of the positional information formed of longitude and latitude, and (b) is a conceptual diagram illustrating the data structure of the positional information converted to coordinate;

FIG. 5 is a flowchart illustrating a processing procedure of coordinate conversion processing executed by the device of the first embodiment;

FIG. 6 is a block diagram schematically illustrating an outline of a vehicle-mounted device according to a second embodiment of the present invention;

FIG. 7 is a schematic diagram illustrating an image displayed on the screen on the basis of the position information processed by the device of the second embodiment;

FIG. 8 is a plan view illustrating an example of the travel environment in which the device of the second embodiment processes the positional information;

FIG. 9 is a diagram schematically illustrating information handled in the second embodiment, in which (a) is a conceptual diagram illustrating a relationship between a vehicle ID and the positional information, (b) is a conceptual diagram illustrating a relationship between the vehicle ID and a local ID of the device, and (c) is a conceptual diagram illustrating a relationship between the local ID and a display relative value;

FIG. 10 is a diagram schematically illustrating positional information handled in the second embodiment, in which (a) is a conceptual diagram illustrating a data structure formed of a difference between the local ID and latitude as well as a difference between the local ID and longitude, and (b) is a conceptual diagram illustrating the data structure of the local ID and difference information converted to coordinate; and

FIG. 11 is a flowchart illustrating a processing procedure of the coordinate conversion processing executed by the device of the second embodiment.

### MODES FOR CARRYING OUT THE INVENTION

### First Embodiment

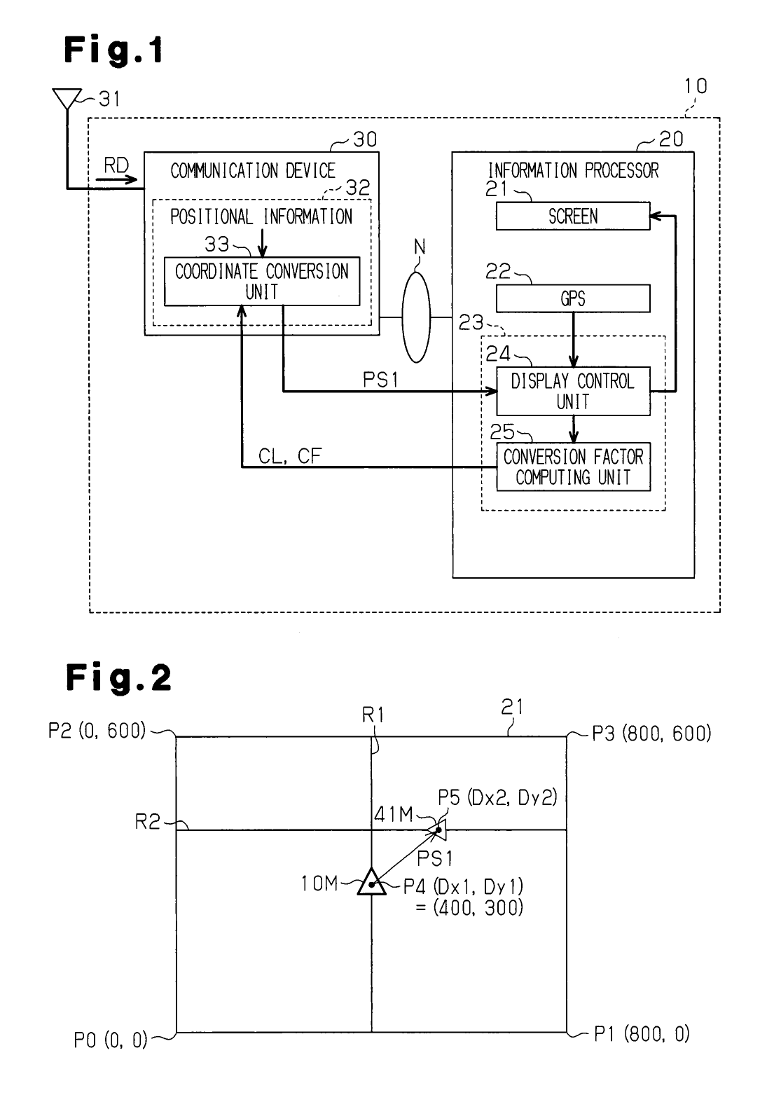

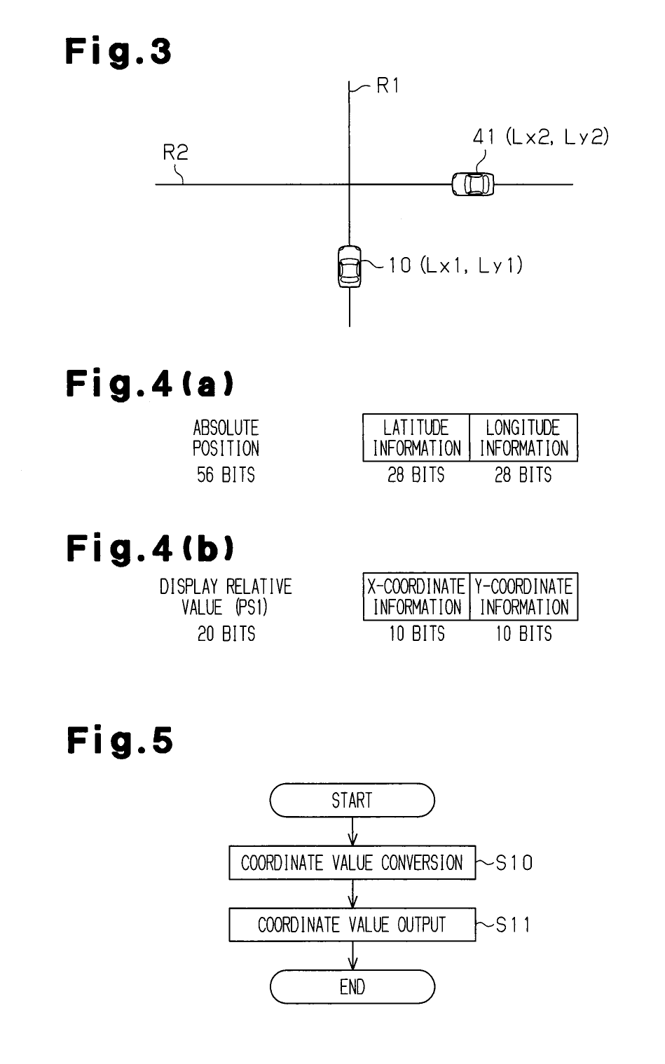

A vehicle-mounted device according to a first embodiment of the present invention will be described below by referring to the attached drawings. FIG. 1 is a block diagram illustrating a system structure of the vehicle-mounted device of this embodiment. FIG. 2 is a schematic diagram illustrating an image displayed on a screen on the basis of positional information. FIG. 3 is a plan view illustrating an example of a travel environment in which the positional information is processed.

As illustrated in FIG. 1, a vehicle 10 has a vehicle-mounted network N and an information processor 20 as a vehicle-mounted information processor, and a communication device 30 as a vehicle-mounted communication device each connected in a communicative manner to the vehicle-mounted network N.

The vehicle-mounted network N enables information transmission between a plurality of devices connected to the vehicle-mounted network N and is composed of a vehicle-mounted local CAN (Controller Area Network) having a maximum communication capacity of 500 kilobits/second (time) in this embodiment. The information processor 20 provides a driver who drives the vehicle 10 with information that can assist a driving operation through image display. The communication device 30 obtains positional information of vehicles other than the vehicle 10 and positional information of ground facilities (stop line and the like) and the like via radio communication with communication devices of the other vehicles and communication devices provided on the road.

The information processor 20 has a screen 21, a global positioning system (GPS) 22, and a computing device 23 for executing various types of computing processing.

The screen 21, as illustrated in FIG. 2, displays an image to be visually discerned by the driver and is composed of a liquid display panel having 800 dots in the horizontal direction (X-direction) and 600 dots in the vertical direction (Y-direction), for example, as resolution. Thus, a coordinate system for display (display coordinate system) divided into 800 in the X-direction and 600 in the Y-direction is defined on the screen 21. On the basis of this display coordinate system, a lower left position P0 in the screen 21 is expressed as a display coordinate (0, 0), which is 0 in the X-direction and 0 in the Y-direction. Moreover, a lower right position P1 is expressed as a display coordinate (800, 0), an upper left position P2 as a display coordinate (0, 600), and an upper right position P3 as a display coordinate (800, 600), respectively. As described above, on the screen 21, by specifying an arbitrary position (display coordinate) in a display region surrounded by each of the positions P0, P1, P2, and P3, a predetermined image can be displayed at the specified position. In this embodiment, the length of the screen 21 in the horizontal direction (X-direction) is assumed to be 200 millimeter (mm) and the length in the vertical direction (Y-direction) to be 150 mm for convenience of explanation. As a result, 4 dots (4 as a value of the coordinate) correspond to the length 1 mm in the horizontal direction (X-direction) of the screen 21, while 4 dots (4 as a value of the coordinate) correspond to the length 1 mm in the vertical direction of the screen 21, too. Moreover, in this embodiment, the advancing direction of the vehicle 10 is assumed to be north and on the screen 21 on which an image is displayed such that the advancing direction of the vehicle 10 comes to the upper side, the upper side of the screen 21 is assumed to be north.

The GPS 22 detects the position of the vehicle 10 on the basis of reception of a GPS satellite signal by latitude and longitude to the magnitude of one hundredth arcseconds and outputs the detected position of the vehicle 10 to the computing device 23. For example, the GPS 22 detects an absolute position (Lx1, Ly1) having the latitude Lx1 and longitude Ly1 as the position of the vehicle 10 advancing on a traveling route R1 as illustrated in FIG. 3. As a result, the absolute position (Lx1, Ly1) of the vehicle 10 is recognized in the information processor 20.

The computing device 23 is composed mainly of a microcomputer provided with a CPU executing various types of computing processing, a ROM storing various control programs, a RAM used as a work area for storing data and executing the program, an input/output interface, a memory and the like. The computing device 23 executes various controls relating to screen display and communication. Thus, the computing device 23 stores in advance various programs for executing screen display and communication and various parameters used for execution of those programs and the like. The various parameters include the size, resolution and the like of the screen 21.

The computing device 23 includes a display control unit 24 and a conversion factor computing unit 25.

The display control unit 24 controls an image displayed on the screen 21 and has image data of map displayed on the screen 21 and also has a predetermined image displayed on a specified display coordinate. In more detail, the display control unit 24 obtains the absolute position of the vehicle 10 output from the GPS 22 and obtains map information around the absolute position (Lx1, Ly1) of the vehicle 10 from a map information database (not shown). Then, by generating image data corresponding to a scale set by the driver and the like from the obtained map information and outputting the result, a map composed of the traveling route R1 and a crossing route R2 is displayed on the screen 21 as illustrated in FIG. 2, for example. The map display on the screen 21 is updated each time the position of the vehicle 10 is updated. Moreover, the display control unit 24 sets the center coordinate (400, 300) of the screen 21 as a display coordinate P4 (Dx1, Dy1) and has an image 10M corresponding to the vehicle 10 displayed at the display coordinate P4. As a result, the position of the vehicle 10 is displayed as the image 10M on the map displayed on the screen 21. The position display of the vehicle 10 is updated each time the display of the map is updated. Moreover, the display control unit 24 has an image 41M corresponding to another vehicle 41 displayed at a display coordinate P5 (Dx2, Dy2). As a result, the other vehicle 41 is also displayed with the vehicle 10 on the map displayed on the screen 21. The position display of the other vehicle 41 is updated each time the display of the map or the position of the other vehicle 41 is updated.

In this embodiment, the display control unit 24 obtains a display relative value PS1 calculated as a relative coordinate to the display coordinate P4 of the vehicle 10 from the outside or the like and adds the display coordinate P4 to the obtained display relative value PS1 so that the display coordinate P5 of the other vehicle 41 as described above can be calculated.

The conversion factor computing unit 25 calculates a conversion factor CF based on a vehicle absolute position CL formed of the latitude and longitude indicating the position of the vehicle 10 set at the center coordinate of the screen 21 and the length (meter) corresponding to 1 dot of the screen 21 determined by the scale of the map displayed on the screen 21. For example, when the scale of the map displayed on the screen 21 is 1/2500, 1 mm (4 dots) on the screen 21 corresponds to 2.5 meters of an actual length, and the length corresponding to 1 dot is 0.625 meters and thus, the conversion factor CF is calculated to be 0.625 meters/dot.

The communication device 30 is a device for conducting vehicle-to-vehicle communication through which vehicle information RD formed of various types of information such as positional information or traveling information of a vehicle is mutually transmitted via radio communication conducted via an antenna 31 for radio communication with other vehicles located around the vehicle 10. In this embodiment, the vehicle information RD is transmitted/received via this vehicle-to-vehicle communication periodically or at every 100 ms, for example, with each of a plurality of vehicles or each of 400 vehicles at the maximum, for example, within a range capable of communication by the communication device 30. The vehicle information RD includes a vehicle ID uniquely given to each vehicle, the absolute position of the vehicle detected by the GPS of the vehicle, a speed of the vehicle, information of the traveling direction of the vehicle and the like. As a result, as illustrated in FIG. 3, the communication device 30 can obtain the vehicle information RD including the absolute position (Lx2, Ly2) of the other vehicle 41 via vehicle-to-vehicle communication with the other vehicle 41.

The vehicle information RD transmitted/received via the vehicle-to-vehicle communication in this embodiment has its communication contents specified. Thus, when each vehicle transmits/receives the vehicle information having the communication contents specified with each other, the received vehicle information of another vehicle can be used as significant. In the vehicle-to-vehicle communication in this embodiment, as illustrated in FIG. 4(a), the absolute position included in the vehicle information RD has a 28-bit data structure in which the latitude is expressed to one hundredth arcseconds and has a 28-bit data structure in which the longitude is expressed to one hundredth arcseconds. As a result, the absolute position is composed having a 56-bit data structure. Describing the data structure in detail, regarding the latitude, a degree (+90 to −90) is expressed by 9 bits, an arcminute (0 to 60) by 6 bits, an arcsecond (0 to 60) by 6 bits, and one hundredth arcseconds (handled as an integer value and 0 to 99) by 7 bits, respectively, so that the latitude is expressed by 28 bits as a whole. Regarding the longitude, a degree (+180 to −180) is expressed by 9 bits, an arcminute (0 to 60) by 6 bits, an arcsecond (0 to 60) by 6 bits, and one hundredth arcseconds (handled as an integer value and 0 to 99) by 7 bits, respectively, so that the longitude is expressed by 28 bits as a whole. As a result, the absolute position (Lx2, Ly2) included in the vehicle information RD of the other vehicle 41 is, for example, composed having a 56-bit data structure formed of the latitude Lx2 and the longitude Ly2.

The communication device 30 includes a computing device 32.

The computing device 32 is composed mainly of a microcomputer provided with a CPU executing various types of computing processing, a ROM storing various control programs, a RAM used as a work area for storing data and executing programs, an input/output interface, a memory and the like. The computing device 32 executes processing of obtaining an absolute position from the vehicle information RD obtained via the vehicle-to-vehicle communication and processing of transmitting/receiving data with the information processor 20. Thus, the computing device 32 stores in advance various programs such as a program for obtaining the absolute position from the vehicle information RD and various parameters used for execution of those programs and the like. The various parameters include information of a data structure for analyzing communication contents of the vehicle information RD communicated via the vehicle-to-vehicle communication, for example.

The computing device 32 includes a coordinate conversion unit 33 for executing coordinate conversion processing for converting a value of the absolute position obtained from the vehicle information RD to a value of the display coordinate system on the screen 21 of the information processor 20. The coordinate conversion unit 33 obtains the absolute position from the vehicle information RD and obtains the vehicle absolute position CL and the conversion factor CF from the information processor 20. Then, the coordinate conversion unit 33 calculates a display relative value PS1 formed of the value of the display coordinate system by converting the absolute position obtained from the vehicle information RD on the basis of the conversion factor CF and outputs the value to the information processor 20.

The coordinate conversion processing in this embodiment will be described by referring to FIG. 5. FIG. 5 is a flowchart illustrating a processing procedure according to the coordinate conversion processing. The computing device 32 starts this coordinate conversion processing each time the absolute position of the other vehicle 41 is obtained.

When the coordinate conversion processing is started, the computing device 32 conducts coordinate conversion of the absolute position of the other vehicle 41 by the coordinate conversion unit 33 (Step S10 in FIG. 5). In the coordinate convention, the coordinate conversion unit 33 obtains the absolute position (Lx2, Ly2) of the other vehicle 41 and obtains the vehicle absolute position CL ((Lx1, Ly1)) and the conversion factor CF from the information processor 20, for example. The vehicle absolute position CL and the conversion factor CF may be held in a predetermined memory after being obtained once and then, re-obtained from the information processor 20 when they are updated.

Then, the coordinate conversion unit 33 acquires a difference between a relative absolute value of the other vehicle 41 to the absolute position of the vehicle 10, that is, a difference between the absolute position of the other vehicle 41 to the absolute position of the vehicle 10. That is, a difference in the latitude (Lx2−Lx1) and a difference in the latitude (Ly2−Ly1) are calculated from the absolute position (Lx2, Ly2) of the other vehicle 41 and the vehicle absolute position CL (Lx1, Ly1), respectively.

Subsequently, the latitude difference (Lx2−Lx1) and the longitude difference (Ly2−Ly1) are converted to lengths. Assuming that a length (meter) per 1 arcsecond latitude is a length La and a length (meter) per 1 arcsecond longitude is a length Lb, the length of the latitude difference is calculated from (Lx2−Lx1)×La and the length of the longitude difference from (Ly2−Ly1)×Lb, respectively. In a district in Japan, the length La per 1 arcsecond latitude is approximately 31 meters and the length Lb per 1 arcsecond longitude is approximately 25 meters.

Then, the length of the latitude difference and the length of the longitude difference are converted to the numbers of dots of the screen 21 on the basis of the conversion factor CF. That is, since the X-direction of the screen 21 corresponds to the longitude and the Y-direction of the screen 21 to the latitude, respectively, the number of dots in the Y-direction of the screen 21 is acquired by dividing the length of the latitude difference by the conversion factor CF, and the number of dots in the X-direction of the screen 21 is acquired by dividing the length in the longitude direction by the conversion factor CF. Specifically, the number of dots in the X-direction ΔDx2 (ΔDx2=(Lx2−Lx1)×La/CF) and the number of dots in the Y-direction ΔDy2 (ΔDy2=(Ly2−Ly1)×Lb/CF) are acquired. As described above, in the coordinate conversion unit 33, the display relative value PS1 (ΔDx2, ΔDy2) of the other vehicle 41 is calculated.

A range of the number of dots in the X-direction ΔDx2 calculated as the display relative value PS1 of the other vehicle 41 is −400 to 400 and a range of the number of dots in the Y-direction ΔDy2 is −300 to 300. That is, the number of dots in the X-direction and the number of dots in the Y-direction including positive/negative signs can be expressed by data in 10 bits, respectively. Thus, the display relative value PS1 can be constituted having a 20-bit data structure formed of 10-bit X-coordinate information (number of dots in X-direction ΔDx2) and 10-bit Y-coordinate information (number of dots in Y-direction ΔDy2) as illustrated in FIG. 4(b).

Then, when the display relative value PS1 of the other vehicle 41 is calculated, the computing device 32 transmits the display relative value PS1 by the coordinate conversion unit 33 to the information processor 20 through the vehicle-mounted network N (Step S11 in FIG. 5) and finishes the coordinate conversion processing. Communication with 400 vehicles at the maximum in a cycle of 100 milliseconds (ms) is possible in the vehicle-to-vehicle communication in this embodiment. Thus, the display relative value PS1 has a data amount of 80 kilobits per second (20×400×10). This data amount occupies 16% of the communication band of the local CAN having the maximum communication capacity of 500 kilobits/second. That is, when this data amount (80 kilobits/second) is to be transferred, occupation on the communication band of the local CAN becomes relatively small, and there is less concern that the communication band for other communications is compressed. Moreover, since high communication efficiency is maintained if the data amount in communication through the local CAN is not more than about 20% of the communication band, high communication efficiency can be also maintained.

On the other hand, the absolute position obtained from the vehicle information RD renders a data amount of 224 kilobits per second ((28+28)×400×10) as it is. If this data amount (224 kilobits/second) is to be transferred through the local CAN having the maximum communication capacity of 500 kilobits/second, a half of the communication band of the local CAN is occupied. In this case, the communication band for other communications is compressed, collision with other communications frequently occurs, and a communication speed lowers, whereby communication efficiency deteriorates. That is, in this case, the communication load of the vehicle-mounted network N is high. On the other hand, according to the communication device 30 of this embodiment, the communication load of the vehicle-mounted network N is maintained low.

As described above, the display relative value PS1 of the other vehicle 41 is transferred from the communication device 30 to the information processor 20. As a result, the information processor 20 obtains the display relative value PS1 by the display control unit 24, and on the basis of the fact that the display relative value PS1 is a relative value to the display coordinate P4 of the vehicle 10, the display coordinate P5 of the screen 21 based on the display relative value PS1 is calculated by adding the display coordinate P4 of the vehicle 10 to the display relative value PS1. For example, by adding the display coordinate P4 (400, 300) of the vehicle 10 to the display relative value PS1 (ΔDx2, ΔDy2), the display coordinate P5 (Dx2, Dy2) having the X-coordinate Dx2 of (ΔDx2+400) and the Y-coordinate Dy2 of (ΔDy2+300) is calculated. As a result, the image 41M corresponding to the other vehicle 41 is displayed at the display coordinate P5 of the screen 21.

A procedure of converting the absolute position of the other vehicle 41 to the display coordinate system of the screen 21, performed in the vehicle-mounted device of this embodiment as above, will be described mainly on the computation contents. It is assumed that the absolute position (Lx1, Ly1) of the vehicle 10 is detected by the GPS (45 degrees, 30 arcminutes, 30.00 arcseconds north latitude, 135 degrees, 30 arcminutes, 30.00 arcseconds east longitude), while the absolute position (Lx2, Ly2) of the other vehicle 41 is obtained via the vehicle-to-vehicle communication of the communication device 30 (45 degrees, 30 arcminutes, 31.00 arcseconds north latitude, 135 degrees, 30 arcminutes, 31.00 arcseconds east longitude).

First, in the display control unit 24 of the information processor 20, the absolute position (Lx1, Ly1) of the vehicle 10 is allocated to the display coordinate P4 (400, 300), which is the center coordinate of the screen 21. The conversion factor computing unit 25 sets the absolute position (Lx1, Ly1) of the vehicle 10 to the vehicle absolute position CL, and 0.625 meters/dot calculated from the size of the screen 21 and the map scale of 1/2500 to the conversion factor CF.

In the communication device 30, the difference between the absolute position (Lx2, Ly2) of the other vehicle 41 and the absolute position (Lx1, Ly1) of the vehicle 10 is acquired. That is, it is acquired that the vehicle 10 has positional difference of 1 arcsecond (45 degrees, 30 arcminutes, 31.00 arcseconds north latitude −45 degrees, 30 arcminutes, 30.00 arcseconds north latitude) in the latitude direction and a difference of 1 arcsecond (135 degrees, 30 arcminutes, 31.00 arcseconds east longitude −135 degrees, 30 arcminutes, 30.00 arcseconds east longitude) in the longitude direction from the other vehicle. Then, a length of the latitude difference and a length of the longitude difference are acquired from the latitude difference and the longitude difference. That is, since the length La per 1 arcsecond latitude is approximately 31 meters, the length of the latitude difference is calculated to be 31 meters (1 arcsecond×31 meters/arcsecond) and since the length Lb per 1 arcsecond longitude is approximately 25 meters, the length of the longitude difference is calculated to be 25 meters (1 arcsecond×25 meters/arcsecond).

Then, the lengths of the differences are converted to the values of the display coordinate system of the screen 21 on the basis of the conversion factor CF, and the display relative value PS1 (ΔDx2, ΔDy2) is acquired. Since the latitude direction corresponds to the Y-direction and the longitude direction to the X-direction on the screen 21, the number of dots ΔDx2 of the length in the X-direction is calculated to be 40 dots (25 meters/(0.625 meters/dot)) and the number of dots ΔDy2 of the length in the Y-direction is calculated to be 50 dots (31 meters/(0.5 meters/dot)). That is, the display relative value PS1 (40, 50) is calculated.

In the information processor 20, the display coordinate P5 (Dx2, Dy2) of the screen 21 is acquired by adding the display coordinate P4 (400, 300) of the vehicle 10 to the display relative value PS1 (40, 50). That is, the display coordinate P5 (Dx2, Dy2) is calculated as the X-coordinate Dx2 of 450 dots ((40+400) and the Y-coordinate Dy2 of 350 dots (50+300). As a result, an image corresponding to the other vehicle 41 is displayed at the display coordinate P5 (450, 350) of the screen 21 on the basis of the display relative value PS1 that can decrease the data amount to be transferred through the vehicle-mounted network N.

As described above, according to the vehicle-mounted device of this embodiment, the advantages enumerated below are obtained.

(1) The positional information of the other vehicle 41, which is a target outside the vehicle obtained by the communication device 30, which information corresponds to the map information specifying the position on the basis of the coordinate system formed of the geographical coordinate system indicating the position by the latitude and longitude, is converted to the coordinate information (display relative value PS1) of the display coordinate system set to limited resolution specified for the screen 21, whereby the data amount is decreased. As a result, the data amount to be transferred from the communication device 30 to the information processor 20 is decreased, and the communication load of the data transfer is also reduced.

(2) Since the display coordinate system corresponding to the screen resolution of the screen 21 is used as the coordinate system set to the limited resolution, the communication device 30 can convert the positional information of the other vehicle 41 to the coordinate information (display relative value PS1) of the display coordinate system suitable for display on the screen 21. As a result, the data amount to be transferred from the communication device 30 to the information processor 20 is decreased, and the other vehicle 41 can be easily displayed with the map on the screen 21.

(3) The positional information of the other vehicle 41 obtained by the communication device 30 is converted to the coordinate information (display relative value PS1) corresponding to the screen resolution of the screen 21 by the conversion factor CF calculated in accordance with the screen resolution of the screen 21 and the scale of the map information. As a result, the communication device 30 can make the coordinate information (display relative value PS1) of the other vehicle 41 on the screen 21 appropriately correspond to the screen resolution of the screen 21 and also correspond to the variously changing scale of the map information timely.

(4) Since the coordinate conversion unit 33 converts the positional information of the other vehicle 41 to the coordinate information (display relative value PS1) from the screen center position (display coordinate P4), the positional information of the other vehicle 41 becomes a numerical value of the difference with respect to the screen center position (display coordinate P4) as the center, and the data amount is reduced. As a result, the positional information by the coordinate system formed of the latitude and longitude of the other vehicle 41 is converted to the coordinate information (display relative value PS1) based on the screen center position (display coordinate P4), and thus, the value becomes a relatively small value according to the screen resolution (0 to 800 (dots), for example) as the value of the coordinate formation, and the data amount of the coordinate information can be made small.

(5) Since the coordinate information (display relative value PS1), whose data amount is made smaller than that of the positional information of the other vehicle 41, is transmitted through the vehicle-mounted network N, the communication load of the vehicle-mounted network N is reduced. The reduction of the communication load of the vehicle-mounted network N reduces the influence on the other communications using the vehicle-mounted network N, and the communication efficiency of a communication system of the vehicle 10 can be favorably maintained.

(6) The data amount of 26 bits (in the case of indication to one hundredth arcseconds), for example, required for a value indicating the latitude or longitude is converted to the coordinate information (display relative value PS1) having a data amount smaller than that. As a result, the data amount to be transmitted to the information processor 20 can be made smaller than the case of transmission of the latitude value or the longitude value as it is, and moreover, the communication load of the data communication between the communication device 30 and the information processor 20 can be reduced.

### Second Embodiment

A vehicle-mounted device according to a second embodiment of the present invention will be described by referring to the attached drawings. This embodiment enables handling of the absolute position of the vehicle updated at each cycle of the vehicle-to-vehicle communication with a smaller data amount. For convenience of explanation, a case applicable to a cycle of this time in the cycles of the vehicle-to-vehicle communication is referred to as the current cycle or the expression of the current cycle is omitted, and a case corresponding to a cycle of the previous time in the cycles of the vehicle-to-vehicle communication, that is, the time 100 ms prior to the current cycle is referred to as previous cycle.

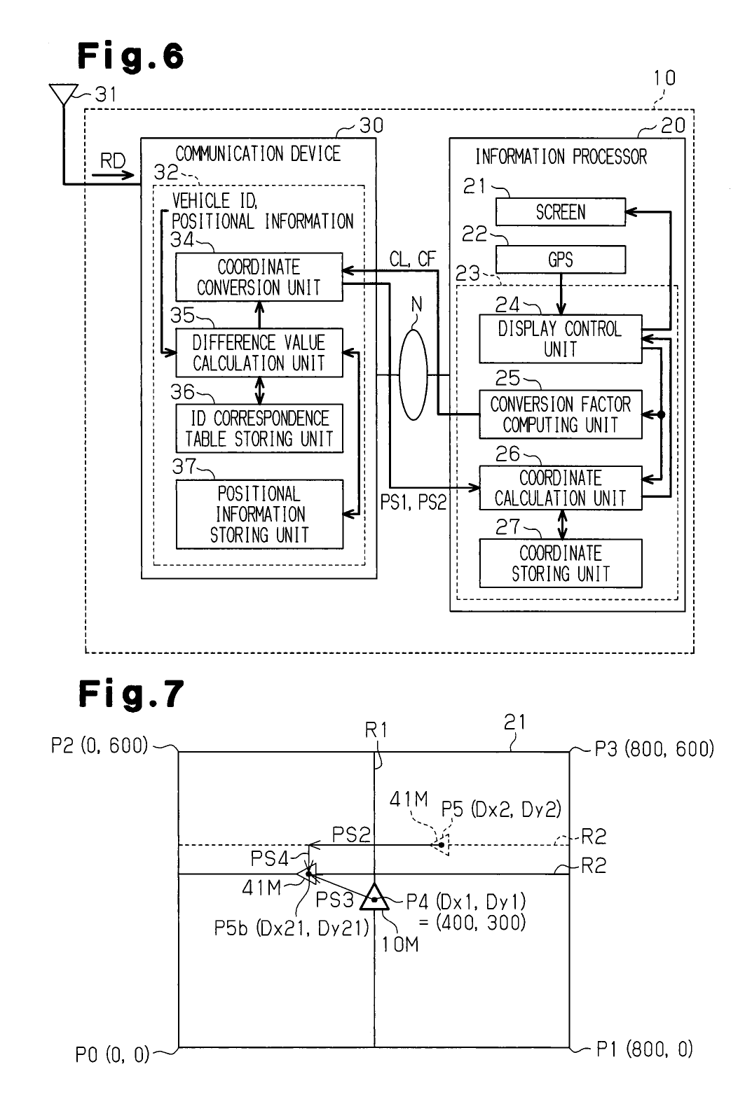

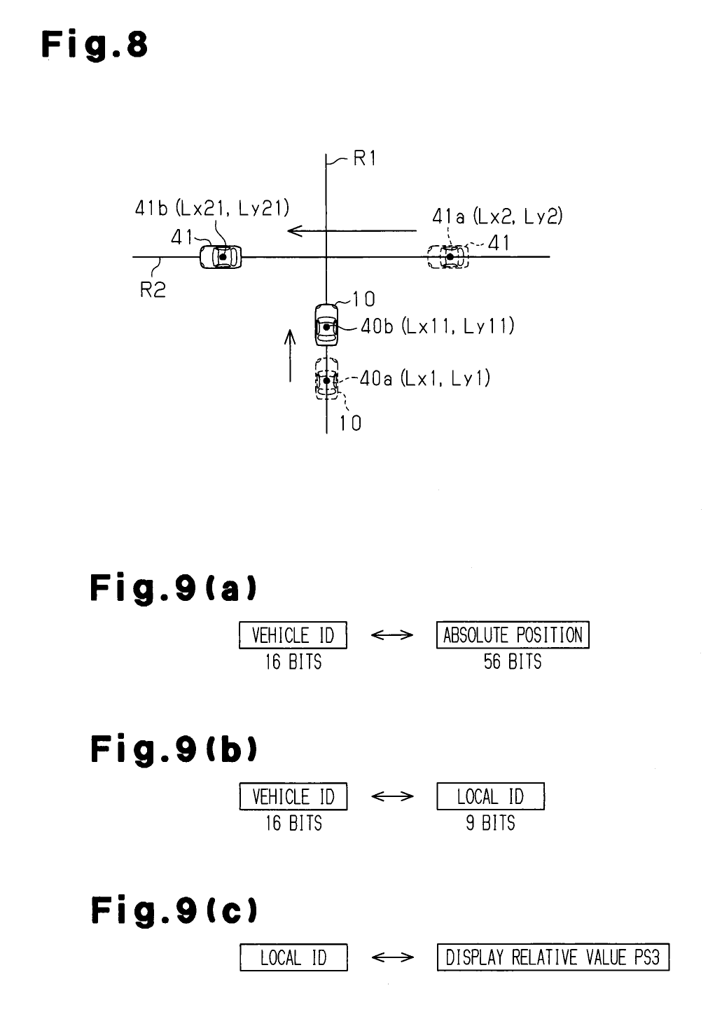

FIG. 6 is a block diagram illustrating a system structure of the vehicle-mounted device according to the present embodiment. FIG. 7 is a schematic diagram illustrating an image displayed on a screen on the basis of positional information. FIG. 8 is a plan view illustrating an example of a travel environment in which the positional information is processed. In this embodiment, a part of the configurations of the information processor 20 and the communication device 30 is different from the above-described first embodiment, while the other configurations are similar, and thus, mainly the difference from the first embodiment will be described, and the members similar to those in the first embodiment are given the same reference numerals and the explanation will be omitted for convenience of explanation.

In this embodiment, too, similarly to the above-described first embodiment, the advancing direction of the vehicle 10 is assumed to be north and, on the screen 21, on which an image is displayed such that the advancing direction of the vehicle 10 comes to the upper side, the upper side of the screen 21 is assumed to be north. Moreover, since the scale of the map displayed on the screen 21 is 1/2500, 1 mm (4 dots) on the screen 21 is assumed to correspond to 2.5 meters in actuality and the length corresponding to 1 dot is assumed to be 0.625 meters. That is, the conversion factor CF is assumed to be 0.625 meters/dot.

As illustrated in FIG. 6, the computing device 23 includes a display control unit 24, the conversion factor computing unit 25, a coordinate calculation unit 26, and a coordinate storing unit 27.

The coordinate storing unit 27 manages/stores data, and data can be written and read by the coordinate calculation unit 26. In the coordinate storing unit 27, as illustrated in FIG. 9(c), a local ID unique in the vehicle 10 and a display relative value PS3 associated with the local ID are stored in association with each other. The display relative value PS3 is a value calculated as a relative coordinate to the display coordinate P4 (See FIG. 7) of the vehicle 10 similarly to the display relative value PS1. Moreover, the coordinate storing unit 27 deletes the local ID not read or written for a predetermined period from the coordinate calculation unit 26 and the associated display relative value PS3. As a result, unnecessary data is erased, and reduction of the storage capacity, suppression of lowering of a search speed of the local ID and the like are realized.

The coordinate calculation unit 26 calculates the display relative value PS3 from a display difference value PS2 as a value of the display coordinate calculated on the basis of the absolute position of another vehicle 41. When the local ID and the display difference value PS2 are obtained from the communication device 30, the coordinate calculation unit 26 calculates the display relative value PS3 of the current cycle on the basis of the display difference value PS2 and the display relative value PS3 of the previous cycle corresponding to the local ID. The display relative value PS3 of the previous cycle is obtained on the basis of the local ID from the coordinate storing unit 27. Then, the display relative value PS3 of the current cycle is output to the display control unit 24. Moreover, the display relative value PS3 of the previous cycle corresponding to the local ID stored in the coordinate storing unit 27 is updated to the display relative value PS3 of the current cycle. When the other vehicle 41 is detected for the first time by the communication device 30, the local ID and the display relative value PS1 corresponding to the other vehicle 41 is obtained from the communication device 30. At this time, the display control unit 24 outputs the obtained display relative value PS1 to the display control unit 24 and has the local ID and the display relative value PS1 stored in the coordinate storing unit 27.

The computing device 32 includes a coordinate conversion unit 34, a difference value calculation unit 35, an ID correspondence table storing unit 36, and a positional information storing unit 37.

The ID correspondence table storing unit 36 manages/stores data, and data can be written and read by the difference value calculation unit 35. In the ID correspondence table storing unit 36, as illustrated in FIG. 9(b), a vehicle ID (16 bits) and a local ID (9 bits) allocated to the vehicle ID are stored in association with each other. Since the local ID is an ID capable of identifying each of the 400 vehicles with which the communication device 30 can communicate simultaneously, it is made of 9 bits capable of expressing 0 to 511. When a local ID of a vehicle ID not stored is requested, the ID correspondence table storing unit 36 selects an unused local ID not allocated to any vehicle ID at that time and allocates it to the vehicle ID and replies the selected local ID. Moreover, the ID correspondence table storing unit 36 deletes the vehicle ID not read or written for a predetermined period and the local ID corresponding to that from the difference value calculation unit 35. As a result, the range of the local IDs is fulfilled by 9 bits (0 to 511).

The positional information storing unit 37 manages/stores data, and data can be written and read by the difference value calculation unit 35. In the positional information storing unit 37, as illustrated in FIG. 9(a), the vehicle ID (16 bits) and the absolute position (56 bits) associated with the vehicle ID are stored in association with each other. The vehicle ID is an identification number (ID) uniquely given to each vehicle, and the vehicle can be specified by the identification number. For example, the same vehicle can be tracked from the absolute position obtained at different times by using the vehicle ID. The positional information storing unit 37 deletes the vehicle ID not read or written for a predetermined time and the associated absolute position from the difference value calculation unit 35. As a result, unnecessary data is erased, and reduction of the storage capacity, suppression of lowering of an obtaining speed of the vehicle ID and the like can be realized.

The difference value calculation unit 35 calculates a difference between the absolute position of the previous cycle and the absolute position of the current cycle for the same vehicle ID. For example, the difference value calculation unit 35 calculates a difference of latitude of (Lx21−Lx2) and a difference of longitude of (Ly21−Ly2) from an absolute position 41a of the previous cycle (Lx2, Ly2) and an absolute position 41b of the current cycle (Lx21, Ly21) for the other vehicle 41 as illustrated in FIG. 8. To do this, the difference value calculation unit 35 obtains the absolute position 41a of the previous cycle of the same vehicle ID from the positional information storing unit 37 on the basis of the vehicle ID of the current cycle. Then, after a difference between the absolute position 41a of the previous cycle and the absolute position 41b of the current cycle is calculated, the absolute position 41a of the previous cycle stored in the positional information storing unit 37 is updated by the absolute position 41b of the current cycle. As a result, the difference between the absolute position of the previous cycle and the absolute position of the current cycle can be calculated next time and after. Moreover, the difference value calculation unit 35 obtains the local ID corresponding to the vehicle ID from the ID correspondence table storing unit 36. Then, the difference value calculation unit 35 outputs the difference of the latitude and the difference of the longitude together with the local ID to the coordinate conversion unit 34. The data amount is decreased by using the local ID (9 bits) instead of the vehicle ID (16 bits).

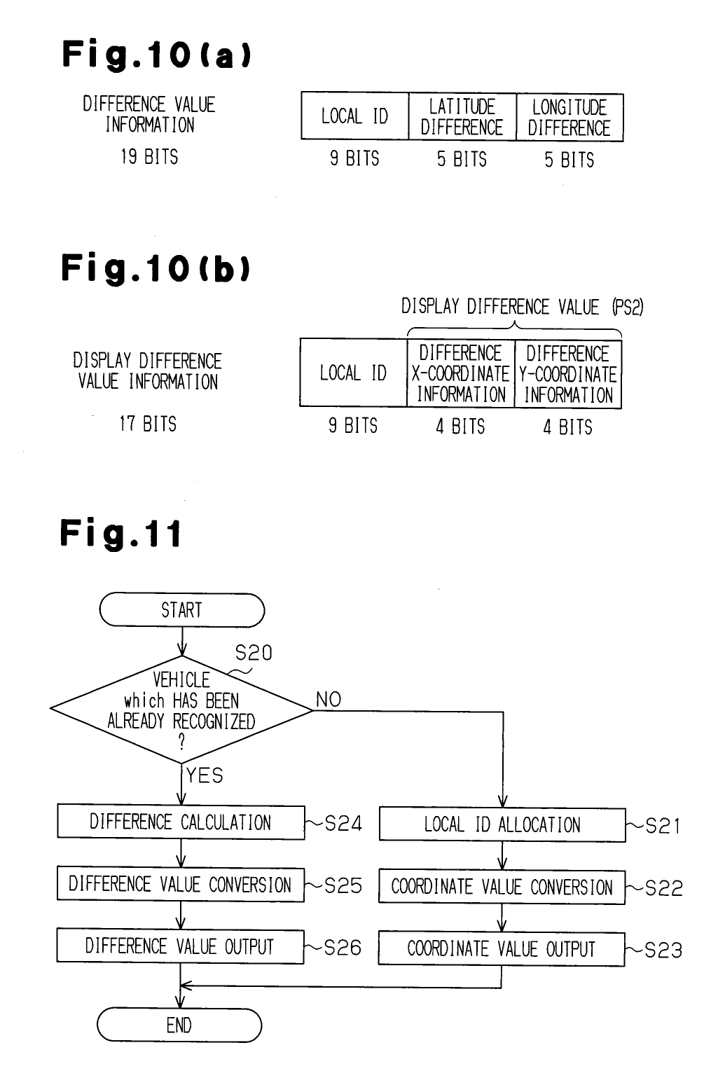

A moving distance of the vehicle 10 per cycle (100 ms) of the vehicle-to-vehicle communication is 5 meters in the case of a vehicle traveling at a speed of 180 km/h, for example. Since it is 31 meters per 1 arcsecond latitude, 5 meters corresponds to 0.16 arcseconds, while since it is 25 meters per 1 arcsecond longitude, 5 meters corresponds to 0.20 arcseconds. If one hundredth arcseconds is expressed in an integer value, at least 5 bits (0 to 31) are required. As a result, the data structure output from the difference value calculation unit 35 to the coordinate conversion unit 34 becomes a data structure of 19 bits made of the local ID, the latitude difference, and the longitude difference as illustrated in FIG. 10(a).

In the case of a vehicle ID for the first time, the difference value calculation unit 35 cannot obtain the absolute position of the previous cycle of the vehicle ID from the positional information storing unit 37 and thus, cannot calculate the difference between the absolute position of the previous cycle and the absolute position of the current cycle. However, even in this case, the vehicle ID of the current cycle and the absolute position of the current cycle associated with the vehicle ID are stored in the positional information storing unit 37. As a result, the difference between the absolute position of the previous cycle and the absolute position of the current cycle can be calculated next time and after. Moreover, the difference value calculation unit 35 tries to obtain the local ID corresponding to the vehicle ID from the ID correspondence table storing unit 36, but since the ID correspondence table storing unit 36 does not have the corresponding local ID, a new local ID is obtained. Thus, in the case of the first-obtained vehicle ID, the difference value calculation unit 35 outputs the absolute position of the current cycle together with the new local ID to the coordinate conversion unit 34.

The coordinate conversion unit 34 executes coordinate conversion processing for converting the value based on the absolute position to a value based on the display coordinate system of the screen 21. The coordinate conversion unit 34 obtains, together with the local ID, the absolute position of the other vehicle 41 or the difference between the absolute position of the previous cycle and the absolute position of the current cycle of the other vehicle 41 from the difference value calculation unit 35. Moreover, the coordinate conversion unit 34 obtains the vehicle absolute position CL and the conversion factor CF from the information processor 20. Then, in the case of another vehicle 41 that is detected for the first time, the coordinate conversion unit 34 calculates the display relative value PS1 expressed by the value of the display coordinate system on the basis of the absolute position (41a) of the other vehicle 41, the vehicle absolute position CL, and the conversion factor CF and outputs the result to the information processor 20. On the other hand, in the case of another vehicle 41 that has been already detected, the coordinate conversion unit 34 calculates the display difference value PS2 on the basis of a difference between the absolute position (41a) of the previous cycle and the absolute position (41b) of the current cycle and the conversion factor CF and outputs the result to the information processor 20. The moving distance of the vehicle 10 per cycle (100 ms) of the vehicle-to-vehicle communication is 5 meters for a vehicle traveling at a speed of 180 km/h, for example. Since 5 meters corresponds to 8 dots (5 meters/0.625 meters/dot), the value of the display coordinate system is also 8. As a result, the difference value in the X-direction (difference X-coordinate information) and the difference value in the Y-direction (difference Y-coordinate information) of the display difference value PS2 indicated by the value of the display coordinate system can be expressed by 4 bits (0 to 15), respectively. Thus, the data structure of the display difference value information output from the communication device 30 to the information processor 20 becomes a 17-bit data structure formed of the local ID and the display difference value PS2 as illustrated in FIG. 10(b).

Subsequently, the coordinate conversion processing of this embodiment will be described with referring to FIG. 11. FIG. 11 is a flowchart illustrating a processing procedure according to the coordinate conversion processing. The computing device 32 starts this coordinate conversion processing each time the absolute position of the other vehicle 41 is obtained.

When the coordinate conversion processing is started, the computing device 32 determines whether the vehicle has been already discerned by the difference value calculation unit 35 or not (Step S20 in FIG. 11). If the obtained vehicle ID has been already stored in the positional information storing unit 37, the vehicle is determined to have been already discerned, while if not, the vehicle is determined not to have been discerned. If the vehicle is determined not to have been discerned (NO at Step S20 in FIG. 11), the computing device 32 allocates a local ID to the vehicle ID by the ID correspondence table storing unit 36 and has the allocated local ID and the absolute position 41a (Lx2, Ly2) of the other vehicle 41 transmitted to the coordinate conversion unit 34 (Step S21 in FIG. 11). Then, the computing device 32 calculates a difference calculated from the absolute position 41a (Lx2, Ly2) of the other vehicle 41 and the vehicle absolute position CL by the coordinate conversion unit 34 and converts the calculated difference to the display relative value PS1, which is a value of the display coordinate system of the screen 21 by the conversion factor CF (Step S22 in FIG. 11). When the display relative value PS1 of the other vehicle 41 is calculated, the coordinate conversion unit 34 outputs the local ID and the display relative value PS1 to the information processor 20 (Step S23 in FIG. 11) and finishes the coordinate conversion processing. As a result, the computing device 32 outputs the display relative value PS1 to the information processor 20 through the vehicle-mounted network N.

On the other hand, if the vehicle is determined to have been already discerned (YES at Step S20 in FIG. 11), the computing device 32 calculates the difference between the absolute position of the previous cycle and the absolute position of the current cycle by the difference value calculation unit 35 (Step S24 in FIG. 11). The difference value calculation unit 35 calculates a difference in the absolute position formed of the latitude difference of (Lx21−Lx2) and the longitude difference of (Ly21−Ly2) from the absolute position 41b of the current cycle and the absolute position 41a of the previous cycle of the other vehicle 41, for example.

Then, the computing device 32 converts the difference of the absolute position calculated by the difference value calculation unit 35 to the display difference value PS2, which is a value of the display coordinate system of the screen 21 (Step S25 in FIG. 11) in the coordinate conversion unit 34. The coordinate conversion unit 34 converts the difference of the absolute position of the other vehicle 41 (Lx21−Lx2, Ly21−Ly2) to the display difference value PS2 ((Lx21−Lx2)/CF, (Ly21−Ly2)/CF) composed as 8-bit data by means of conversion on the basis of the conversion factor CF, for example. When the display difference value PS2 of the other vehicle 41 is calculated, the coordinate conversion unit 34 outputs the display relative value information formed of the local ID (9 bits) and the display difference value PS2 (8 bits) (Step S26 in FIG. 11) and finishes the coordinate conversion processing. That is, the computing device 32 outputs the display relative value information (17 bits) to the information processor 20 through the vehicle-mounted network N.

In the vehicle-to-vehicle communication of this embodiment, communication can be conducted with 400 vehicles at the maximum in a cycle of 100 milliseconds (ms). Thus, the display difference value information has a data amount of 68 kilobits (17×400×10) per second. This data amount occupies 13.6% of the communication band of the local CAN having the maximum communication capacity of 500 kilobits/second. That is, if this data amount (68 kilobits/second) is to be transferred through the local CAN, occupation of the communication band becomes relatively small, and there is less concern that the communication band of other communications is compressed. Moreover, since high communication efficiency is maintained in the local CAN when the data amount to be communicated is approximately 20% or less of the communication band, high communication efficiency can be also maintained.

As described above, the display difference value information of the other vehicle 41 is transferred from the communication device 30 to the information processor 20.

In the information processor 20, the display difference value information is obtained by the coordinate calculation unit 26, and the display relative value PS3 corresponding to the local ID included in the display difference value information is obtained from the coordinate storing unit 27. Then, a new display difference value PS3 is calculated on the basis of the display relative value PS3 of the previous cycle obtained from the coordinate storing unit 27, the display difference value PS2 of the current cycle, and a movement amount PS4 of the vehicle 10 from the previous cycle to the current cycle. That is, since the display coordinate P4 of the vehicle 10 of the screen 21 is not moved, the new display relative value PS3 is calculated by reflecting the movement amount PS4 of the vehicle 10 to the other vehicle 41. In more detail, the display difference value PS2 of the current cycle is added to the display relative value PS3 of the previous cycle, and the movement amount PS4 which is a value of the display coordinate system corresponding to the moving distance of the vehicle 10 is subtracted. The movement amount PS4 is calculated as a value of the display coordinate system (number of dots) of the screen 21 by dividing the moving distance calculated from the absolute position 40a (Lx1, Ly1) of the previous cycle and the absolute position 40b (Lx11, Ly11) of the current cycle of the vehicle 10 by the conversion factor CF of 0.625 meters/dot. Then, the display relative value PS3 is output from the coordinate calculation unit 26 to the display control unit 24.

If the display relative value PS3 is obtained, the display control unit 24 calculates a display coordinate P5b of the screen 21 by adding the display coordinate P4 of the vehicle 10 to the display relative value PS3 on the basis of the fact that the display relative value PS3 is a relative value to the display coordinate P4 of the vehicle 10. For example, the display coordinate P5b (Dx21, Dy21) having the X-coordinate Dx21 of (ΔDx21+400) and the Y-coordinate Dy21 of (ΔDy21+300) is calculated by adding the display coordinate P4 (400, 300) of the vehicle 10 to the display relative value PS3 (ΔDx21, ΔDy21). As a result, the image 41M corresponding to the other vehicle 41 is displayed at the position of the display coordinate P5b on the screen 21.

On the other hand, in the case of another vehicle 41 that is detected for the first time, the display control unit 24 obtains the display relative value PS1. Then, the display coordinate P5 of the screen 21 is calculated by adding the display coordinate P4 of the vehicle 10 to the display relative value PS1 on the basis of the fact that the display relative value PS1 is a relative value to the display coordinate P4 of the vehicle 10. For example, the display coordinate P5 (Dx2, Dy2) having the X-coordinate Dx2 of (ΔDx2+400) and the Y-coordinate Dy2 of (ΔDy2+300) is calculated by adding the display coordinate P4 (400, 300) of the vehicle 10 to the display relative value PS1 (ΔDx2, ΔDy2). As a result, the image 41M corresponding to the other vehicle 41 is displayed at the position of the display coordinate P5 on the screen 21.

A procedure of converting the absolute position of the other vehicle 41 to the display coordinate system of the screen 21 executed in the vehicle-mounted device of this embodiment as above will be described mainly on the computation contents.

It is assumed that the vehicle 10 is traveling in the north direction, while the other vehicle 41 is traveling in the east direction unlike in FIG. 7. As a result, the absolute position 40a (Lx1, Ly1) of the previous cycle of the vehicle 10 detected by the GPS 22 is assumed to be (135 degrees, 30 arcminutes, 30.00 arcseconds east longitude, 45 degrees, 30 arcminutes, 30.00 arcseconds north latitude), while the absolute position 40b (Lx11, Ly11) of the current cycle is assumed to be (135 degrees, 30 arcminutes, 30.00 arcseconds east longitude, 45 degrees, 30 arcminutes, 30.10 arcseconds north latitude). Moreover, the absolute position 41a (Lx2, Ly2) of the previous cycle of the other vehicle 41 obtained via the vehicle-to-vehicle communication of the communication device 30 is assumed to be (135 degrees, 30 arcminutes, 31.00 arcseconds east longitude, 45 degrees, 30 arcminutes, 31.00 arcseconds north latitude), while the absolute position 41b (Lx21, Ly21) of the current cycle is assumed to be (135 degrees, 30 arcminutes, 31.10 arcseconds east longitude, 45 degrees, 30 arcminutes, 31.00 arcseconds north latitude).

First, in the display control unit 24 of the information processor 20, the absolute position 40b (Lx11, Ly11) of the vehicle 10 is allocated to the display coordinate P4 (400, 300), which is the center coordinate of the screen 21. The conversion factor computing unit 25 sets the absolute position 40b (Lx11, Ly11) of the vehicle 10 to the vehicle absolute position CL, and 0.625 meters/dot calculated from the size of the screen 21 and the map scale of 1/2500 is set to the conversion factor CF, and they are output to the communication device 30, respectively.

In the communication device 30, the absolute position 41a of the previous cycle (Lx2, Ly2) is obtained from the vehicle ID of the other vehicle 41, and the difference from the absolute position 41b (Lx21, Ly21) of the current cycle is calculated. That is, a difference of latitude is calculated to be 0 arcseconds (Ly21−Ly2=45 degrees, 30 arcminutes, 31.00 arcseconds north altitude −45 degrees, 30 arcminutes, 31.00 arcseconds north latitude), while a difference in longitude is calculated to be 0.1 arcseconds (Lx2−Lx21=135 degrees, 30 arcminutes, 31.10 arcseconds east longitude −135 degrees, 30 arcminutes, 31.00 arcseconds east longitude). Then, the length of the latitude difference and the length of the longitude difference are calculated from the latitude difference and the longitude difference. That is, since the length La per 1 arcsecond latitude is approximately 31 meters, the length of the difference in the latitude (Y-direction) is calculated to be 0 meters (0 arcseconds×31 meters/arcsecond). Moreover, since the length Lb per 1 arcsecond longitude is approximately 25 meters, the length of the difference in the latitude (X-direction) is calculated to be 2.5 meters (0.1 arcseconds×25 meters/arcsecond).

Then, the lengths of the differences are converted to values of the display coordinate system of the screen 21 on the basis of the conversion factor CF. Since the latitude direction corresponds to the Y-direction and the longitude direction to the X-direction on the screen 21, the length in the Y-direction is calculated to be 0 dots (0 meters/(0.625 meters/dot)) and the length in the X-direction is calculated to be 4 dots (2.5 meters/(0.625 meters/dot)). This is output as the display difference value PS2 (4, 0) together with the local ID to the information processor 20 through the vehicle-mounted network N.

In the coordinate calculation unit 26 of the information processor 20, the new display relative value PS3 is calculated from the display difference value PS2, the display relative value PS3 of the previous cycle, and the movement amount PS4 of the vehicle 10.

The display relative value PS3 of the previous cycle is calculated on the basis of the difference between the absolute position 41a of the previous cycle of the other vehicle 41 and the absolute position 40a of the previous cycle of the vehicle 10. For example, the value in the X-direction is calculated as 40 ((Lx2−Lx1)×La/CF=(135 degrees, 30 arcminutes, 31.00 arcseconds east longitude −135 degrees, 30 arcminutes, 30.00 arcseconds east longitude)×25/(0.625 meters/dot)). Moreover, the value in the Y-direction is calculated as 50 ((Ly2−Ly1)×Lb/CF=(45 degrees, 30 arcminutes, 31.00 arcseconds north latitude −45 degrees, 30 arcminutes, 30.00 arcseconds north latitude)×31/(0.625 meters/dot)). That is, the display relative value PS3 of the previous cycle is (40, 50).

Moreover, the movement amount PS4 of the vehicle 10 is calculated on the basis of the difference between the absolute position 40a of the previous cycle and the absolute position 40b of the current cycle. For example, the value in the X-direction is calculated as 0 ((Lx11−Lx1)×La/CF=(135 degrees, 30 arcminutes, 30.00 arcseconds east longitude −135 degrees, 30 arcminutes, 30.00 arcseconds east longitude)×25/(0.625 meters/dot)). Moreover, the value in the Y-direction is calculated as 5 ((Ly11−Ly1)×Lb/CF=(45 degrees, 30 arcminutes, 31.10 arcseconds north latitude −45 degrees, 30 arcminutes, 30.00 arcseconds north latitude)×31/(0.625 meters/dot)). That is, the movement amount PS4 of the vehicle 10 is (0, 5).

In the coordinate calculation unit 26, a new display relative value PS3 is calculated by adding the display difference value PS2 (4, 0) to the display relative value PS3 of the previous cycle (40, 50) and by subtracting the movement amount PS4 (0, 5). That is, the relative value 44 (40+4−0) in the X-direction and the relative value 45 (50+0−5) in the Y-direction are calculated. That is, the new display relative value PS3 is (44, 45).

In the display control unit 24 of the information processor 20, the display coordinate P5b of the screen 21 (Dx21, Dy21)=(444, 345) is calculated by adding the display coordinate P4 (400, 300) of the vehicle 10 to the display relative value PS3 (44, 45) calculated in the coordinate calculation unit 26. As a result, the image 41M corresponding to the other vehicle 41 is displayed at the display coordinate P5b (444,345) of the screen 21 on the basis of the display difference value PS2 with a smaller data amount. At this time, if the image 41M of the other vehicle 41 is illustrated in FIG. 7, for example, the image 41M is located at a position closer to the right side than the image 41M of the other vehicle 41 in the X-direction and at a position closer to the image 10M of the vehicle 10 than the image 41M of the other vehicle 41 in the Y-direction.

As described above, with this embodiment, too, the advantages the same as or similar to those of the above-described (1) to (6) of the first embodiment can be obtained, and the advantages enumerated below can be obtained.

(7) Since the coordinate information (display difference value PS2) based on the movement amount of the other vehicle 41 is transferred from the communication device 30 to the information processor 20, the data amount can be made smaller than that in transfer of the positional information made of latitude and longitude. In the case of the movement amount, if the cycle for calculating the movement amount is short like 100 ms, the movement amount of the other vehicle 41 becomes small, and the data amount can be further decreased.

Each of the above-described embodiments may be modified as follows, for example.

In each of the above-described embodiments, an example is illustrated in which the display relative value PS1 converted to the value of the display coordinate system in the communication device 30 is output to the information processor 20. However, if the display relative value converted to the value of the display coordinate system is not included in the display region on the screen of the information processor, the communication device does not need to output the display relative value to the information processor. As a result, the display relative value that cannot be displayed on the screen can be excluded from the communication data, and the communication load can be reduced.

In each of the above-described embodiments, an example is illustrated in which the information processor 20 provides a driver who drives the vehicle 10 with the information capable of assisting the driving operation. However, the information processor may provide information through sound, voice, light, vibration and the like or may provide speed reduction control or stop control of the vehicle such as brake assist or fuel cut-off operation. As a result, the range of assistance to be provided is expanded, and the possibility of employment as a vehicle-mounted device is heightened. For example, the vehicle-mounted device can be employed for a driving assisting device by car navigation or a driving assisting device including speed reduction control or stop control.

In each of the above-described embodiments, an example is illustrated in which the advancing direction of the vehicle 10 is north, but the advancing direction of the vehicle may be a direction other than north such as south, east or west. In this case, the screen, on which the image is displayed so that the advancing direction comes to the upper side, may have inclination generated between its coordinate system and the coordinate system of the latitude and longitude, but it is only necessary to convert the latitude and longitude to the coordinate system of the screen by considering the inclination. In each of the above-described embodiments, too, it is possible to convert the position formed of the latitude and longitude to the display coordinate system of the screen by considering the inclination between the coordinate system of the screen and the coordinate system of the latitude and longitude through transmission of the advancing direction of the vehicle 10 from the information processor 20 to the communication device 30.

In each of the above-described embodiments, an example is illustrated in which the maximum communication capacity of the vehicle-mounted local CAN is 500 kilobits/second, but the maximum communication capacity may be larger or smaller than 500 kilobits/second. In any case, the communication load is reduced since the data amount relating to the positional information is decreased.

In each of the above-described embodiments, an example is illustrated in which the vehicle-mounted network N is a local CAN for vehicle-mount. However, the vehicle-mounted network is not so limited and may be another network such as Ethernet (registered trademark), FlexRay and the like. Regardless of which type of network is used, the data amount relating to positional information is decreased, whereby the communication load is reduced.

In the above-described second embodiment, an example is illustrated in which a difference between the absolute position of the previous cycle and the absolute position of the current cycle is calculated, but a difference between the number of dots the previous cycle and the number of dots of the current cycle may be acquired. In this case, by holding the number of dots of the previous cycle, the difference can be acquired by converting the absolute position of the current cycle to the number of dots.

In each of the above-described embodiments, an example is illustrated in which the communication device 30 conducts vehicle-to-vehicle communication. However, the communication device is not so limited and may be an infra-red communication device, which conducts communication with an optical beacon device and the like provided on a road by using an optical signal such as an infrared signal.

In each of the above-described embodiments, an example is illustrated in which the target is only the other vehicle 41, but the target is not so limited, and there may be two or more targets. Even if there are two or more targets, since the communication load is reduced, the number of types of coordinate information of other vehicles that can be transferred is increased. As a result, the number of vehicles recognized by the vehicle-mounted information processor is increased, and driving assistance can be further sophisticated.

In each of the above-described embodiments, an example is illustrated in which the vehicle absolute position CL is set as an absolute position corresponding to the center coordinate of the screen 21. However, the latitude and longitude information may be set as the absolute position to the predetermined coordinate of the screen.

In each of the above-described embodiments, the conversion factor CF is calculated by using the unit of meters/dot but the calculation may be made by using the unit of dot/meters.

In each of the above-described embodiments, an example is illustrated in which the conversion factor CF is calculated on the basis of the map scale. However, the conversion factor may be a relationship between the dot and the longitude and the relationship between the dot and the latitude.

In each of the above-described embodiments, an example is illustrated in which there is one conversion factor CF and the unit is meters/dot. However, two conversion factors, that is, a conversion factor indicating the relationship between the dot and the latitude and a conversion factor indicating the relationship between the dot and longitude may be used.

Moreover, it may be so configured that absolute positions to predetermined three coordinates forming a triangle on the screen are output as three conversion factors to the communication device, respectively, so that the relationship between the dots and the latitude and the relationship between the dots and the longitude can be calculated in the communication device. In this case, the vehicle absolute position CL can be omitted.

In each of the above-described embodiments, an example is illustrated in which the screen 21 is composed of a liquid crystal display panel. However, the screen may be another display device such as a CRT, a plasma display, an organic EL display or the like. Whatever the display device is, the position to display the target on the screen can be set from the relationship between the size of the display screen and the corresponding bits. As a result, freedom to select a display screen is improved, and design freedom as a vehicle-mounted device is also improved.

In each of the above-described embodiments, an example is illustrated in which the resolution of the screen 21 is 800 dots in the horizontal direction and 600 dots in the vertical direction (800×600). However, the resolution of the screen may be higher or lower than (800×600). Whatever the resolution is, a position to display the target on the screen can be set from the relationship between the size of the display screen and the corresponding bits. As a result, the resolution of the display screen can be selected from a wider range of choices, and design freedom as a vehicle-mounted device is also improved.

In each of the above-described embodiments, an example is illustrated in which the length in the horizontal direction (X-direction) of the screen 21 is 200 mm and the length in the vertical direction (Y-direction) is 150 mm. However, the length in the horizontal direction of the screen may be longer or shorter than 200 mm. Moreover, the length in the vertical direction of the screen may be longer or shorter than 150 mm. That is, regardless of the size of the display device, a position to display the target can be set on the screen from the relationship between the size of the display and the corresponding bits. As a result, the display screen size can be selected from a wider range of choices, and design freedom as a vehicle-mounted device is also improved.

In each of the above-described embodiments, an example is illustrated in which the target is the other vehicle 41, however, the target may be any moving body such as various types of vehicles (including motorcycles and bicycles), human beings and the like, facilities such as a traffic light, an intersection, a stop line and the like, traffic jam information such as a traffic jam section, a traffic jam degree and the like, road traffic information indicating the position of a road closure and the like. As a result, too, the data amount can be decreased by converting the positional information of the target obtained through the communication device to the coordinate information, and thus, the data communication between the communication device and the information processor is decreased as compared with the transfer of the positional information, and the communication load of the communication for transfer can be reduced.

In each of the above-described embodiments, the invention is exemplified by the use of the absolute coordinate system formed of the latitude and longitude. However, as long as the traveling position of a vehicle can be specified, the absolute coordinate system may be any of various map coordinate systems or various geographical coordinate systems, which are not expressed by the latitude and longitude. Even in such a case, the display coordinate system of the screen is usually smaller, and therefore the data amount is decreased.

In each of the above-described embodiments, the invention is exemplified by conversion of the absolute coordinate system to the display coordinate system of the screen 21. However, the coordinate system for conversion may be a coordinate system virtually set in the information processor or the like as long as the data amount can be decreased as compared with the expression by the absolute coordinate system. As a result, a possibility of employment of such a vehicle-mounted device is improved.

### DESCRIPTION OF THE REFERENCE NUMERALS

10 vehicle
10M image
20 information processor
21 screen as display device
22 global positioning system (GPS)
23 computing device
24 display control unit
25 conversion factor computing unit as conversion factor calculation unit
26 coordinate calculation unit
27 coordinate storing unit
30 communication device
31 antenna
32 computing device
33 coordinate conversion unit
34 coordinate conversion unit
35 difference value calculation unit
36 ID correspondence table storing unit
37 positional information storing unit
41 another vehicle
41M image
N vehicle-mounted network
R1 advancing route
R2 crossing route

1. A vehicle-mounted device, which is configured to discern a target positional information, which is a positional relationship with a target, on the basis of map information, the device comprising:
a vehicle-mounted communication device for obtaining target positional information, which is positional information of the target; and
a vehicle-mounted information processor, which discerns the target positional relationship by processing the target positional information as required, wherein
the vehicle-mounted information processor is provided with a display device having a screen, on which the target positional information and the map information are visualized and displayed,
the vehicle-mounted communication device includes a coordinate conversion unit, which uses a conversion factor to convert the target positional information to coordinate information of a coordinate system that corresponds to a resolution of the screen,
the vehicle-mounted communication device is configured to transfer the coordinate information to the vehicle-mounted information processor, and
the vehicle-mounted information processor includes a conversion factor computing unit, which calculates the conversion factor on the basis of a scale in each case of the map information and the screen resolution.

2. The vehicle-mounted device according to claim 1, wherein
the conversion factor is transferred from the conversion factor computing unit to the coordinate conversion unit,
the conversion factor includes information indicating a center position of the screen corresponding to the map information, and
the coordinate conversion unit is configured to conduct the conversion such that the coordinate information indicates coordinate information from the center position.

3. The vehicle-mounted device according to claim 1, wherein
the target is a communication destination vehicle in vehicle-to-vehicle communication,
each communication destination vehicle is identified by identification information,
the target positional information is positional information of the communication destination vehicle,
the vehicle-mounted communication device is configured to obtain the target positional information and the identification information of each communication destination vehicle through the vehicle-to-vehicle communication,
the coordinate conversion unit converts the target positional information of each communication destination vehicle into the coordinate information, and
the coordinate conversion unit is configured to transfer the coordinate information of each communication destination vehicle to the vehicle-mounted information processor.

4. The vehicle-mounted device according to claim 3, wherein
the vehicle-mounted communication device is further provided with a function of calculating a moving amount of each communication destination vehicle,
the coordinate conversion unit converts the moving amount to calculate moving-amount coordinate information, which is information corresponding to the moving amount of each communication destination vehicle, and
the vehicle-mounted communication device is configured to transfer the moving-amount coordinate information of each communication destination vehicle to the vehicle-mounted information processor.

5. The vehicle-mounted device according to claim 1, wherein
the vehicle-mounted communication device and the vehicle-mounted information processor are connected to each other through a vehicle-mounted network, and
the coordinate information is configured to be transferred from the vehicle-mounted communication device to the vehicle-mounted information processor via the vehicle-mounted network.

6. The vehicle-mounted device according to claim 1, wherein the target positional information includes at least one of a value of latitude and a value of longitude.

7. A vehicle-mounted information processor, which is configured to discern a target positional information, which is a positional relationship with a target, on the basis of map information,
target positional information, which is positional information of the target, is obtained by a vehicle-mounted communication device,
the vehicle-mounted information processor is configured to discern the target positional relationship by processing the target positional information as required,
the vehicle-mounted information processor includes a conversion factor calculation unit, which calculates a conversion factor for converting the target positional information to coordinate information of a coordinate system having a resolution that is set to a limited value with respect to the map information, and
the vehicle-mounted information processor is configured to transfer the conversion factor to the vehicle-mounted communication device.

8. The vehicle-mounted information processor according to claim 7, further comprising a display device having a screen, on which the target positional information and the map information are visualized and displayed,
wherein the conversion factor calculation unit is configured to calculate the conversion factor on the basis of a scale in each case of the map information and a resolution of the screen.

9-12. (canceled)
